(19) United States
(12) Patent Application Publication
(10) Pub. No.: US 2003/0058932 A1
(43) Pub. Date: Mar. 27, 2003

(54) Viseme based video coding

(75) Inventor: Kiran Challapali, New City, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/961,991

(22) Filed: Sep. 24, 2001

(51) Int. Cl. H04N 7/12

(52) U.S. Cl. 375/240.01; 375/240.12; 375/240.21; 375/240.25

(57) ABSTRACT

A video processing system and method for processing a stream of frames of video data. The system comprises a packaging system that includes: a viseme identification system that determines if frames of inputted video data correspond to at least one predetermined viseme; a viseme library for storing frames that correspond to the at least one predetermined viseme; and an encoder for encoding each frame that corresponds to the at least one predetermined viseme, wherein the encoder utilizes a previously stored frame in the viseme library to encode a current frame. Also provided is a receiver system that includes: a decoder for decoding encoded frames of video data; a frame reference library for storing decoded frames; and wherein the decoder utilizes a previously decoded frame from the frame reference library to decode a current encoded frame, and wherein the previously decoded frame belongs to the same viseme as the current encoded frame.

### BACKGROUND OF THE INVENTION

1. Technical Field

The present invention relates to video encoding and decoding, and more particularly relates to a viseme based system and method for coding video frames.

2. Related Art

As the demand for remote video processing applications (e.g., video conferencing, video telephony, etc.) continues to grow, the need to provide systems that can efficiently transmit video data over a limited bandwidth has become critical. One solution for reducing bandwidth consumption is to utilize video-processing systems that can encode and decoded compressed video signals.

There are presently two classes of technology for achieving video compression, waveform-based compression and model-based compression. Waveform based compression is a relatively mature technology that utilizes compression algorithms, such as those provided by the MPEG and ITU standards (e.g., MPEG-2, MPEG-4, H.263, etc.). Model-based compression, alternatively, is a relatively immature technology. Typical approaches used in model-based compression include generating a three dimensional model of the face of a person, and then deriving two dimensional images that form the basis of a new frame of video data. In cases where much of the transmitted video image data is repetitive, such as with a head and shoulder image, model-based coding can achieve much higher degrees of compression.

Thus, while current model-based compression techniques lend themselves well to applications such as video conferencing and video telephony, the computational complexities involved in generating and processing three-dimensional images tends to make such systems difficult to implement and cost prohibitive. Accordingly, a need exists for a coding system that can achieve the compression levels of model-based systems, without requiring the computational overhead of processing three-dimensional images.

### SUMMARY OF THE INVENTION

The present invention addresses the above-mentioned problems, as well as others, by providing a novel model-based coding system. In particular, inputted video frames are decimated such that only a subset of the total frames is actually encoded. Those frames that are encoded are encoded using predictions from the previously coded frame and/or from a frame from a dynamically generated viseme library.

In a first aspect, the invention provides a video processing system for processing a stream of frames of video data, comprising a packaging system that includes: a viseme identification system that determines if frames of inputted video data correspond to at least one predetermined viseme; a viseme library for storing frames that correspond to the at least one predetermined viseme; and an encoder for encoding each frame that corresponds to the at least one predetermined viseme, wherein the encoder utilizes a previously stored frame in the viseme library to encode a current frame.

In a second aspect, the invention provides a method for processing a stream of frames of video data, comprising the steps of: determining if each frame of inputted video data corresponds to at least one predetermined viseme; storing frames that correspond to the at least one predetermined viseme in a viseme library; and encoding each frame that corresponds to the at least one predetermined viseme, wherein the encoding step utilizes a previously stored frame in the viseme library to encode a current frame.

In a third aspect, the invention provides a program product stored on a recordable medium, which when executed, processes a stream of frames of video data, the program product comprising: a system that determines if frames of inputted video data correspond to at least one predetermined viseme; a viseme library for storing frames that correspond to the at least one predetermined viseme; and a system for encoding each frame that corresponds to the at least one predetermined viseme, wherein the encoding system utilizes a previously stored frame in the viseme library to encode a current frame.

In a fourth aspect, the invention provides a decoder for decoding encoded frames of video data that were encoded using frames associated with at least one predetermined viseme, comprising: a frame reference library for storing decoded frames, wherein the decoder utilizes a previously stored frame in the frame reference library to decode a current encoded frame, and wherein the previously stored frame belongs to the same viseme as the current encoded frame; and a morphing system that reconstructs frames of video data that were eliminated during an encoding process.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a video packaging system having an encoder in accordance with a preferred embodiment of the present invention.

FIG. 2 depicts a video receiver system having a decoder in accordance with a preferred embodiment of the present invention.

### DETAILED DESCRIPTION OF THE INVENTION

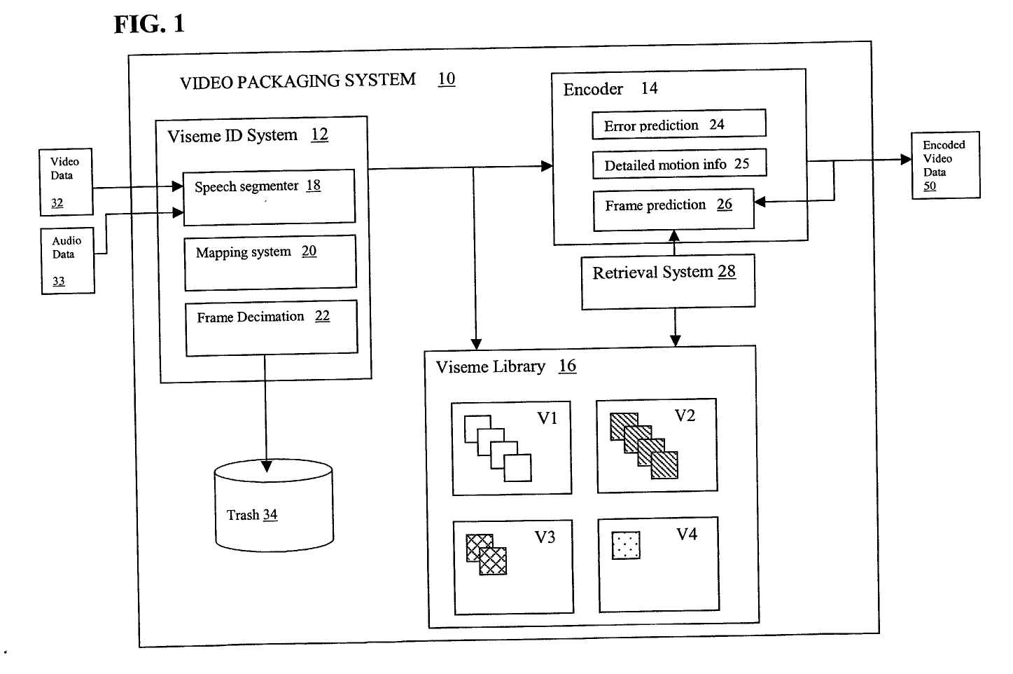

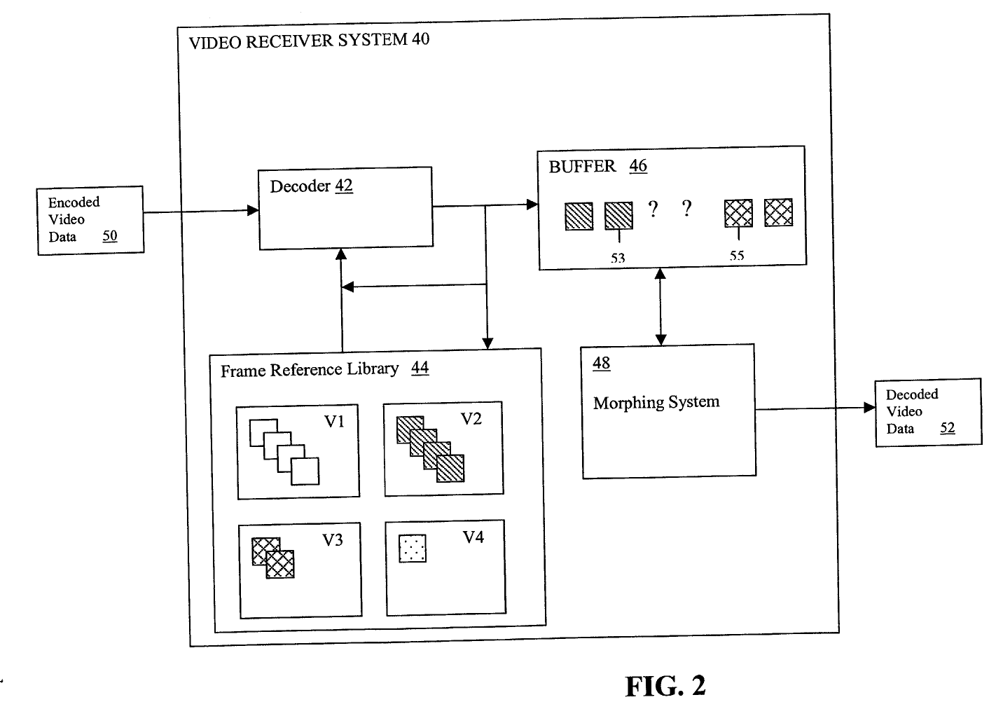

Referring now to the drawings, FIGS. 1 and 2 depict a video processing system for coding video images. While the embodiments described herein focus primarily on applications involving the processing of facial images, it should be understood that the invention is not limited to coding facial images. FIG. 1 depicts a video packaging system 10 that includes an encoder 14 for generating encoded video data 50 from inputted frames of video data 32 and audio data 33. FIG. 2 depicts a video receiver system 40 that includes a decoder 42 for decoding video data 50 encoded by the video packaging system 10 of FIG. 1, and generating decoded video data 52.

The video packaging system 10 of FIG. 1 processes inputted frames of video data 32 using a viseme identification system 12, an encoder 14, and a viseme library 16. In an exemplary application, the inputted frames of video data 32 may comprise a large number of images of a human face, such as that typically processed by a video conferencing system. The inputted frame 32 is examined by viseme identification system 12 to determine which frames correspond to one ore more predetermined visemes. A viseme may be defined as a generic facial image that can be used to describe a particular sound (e.g., forming the mouth shape necessary to utter “sh”). A viseme is the visual equivalent of a phoneme or unit of sound in spoken language.

The process of determining which images correspond to a viseme is accomplished by speech segmenter 18, which identifies phonemes in the audio data 33. Each time a phoneme is identified, the corresponding video image can be tagged as belonging to a corresponding viseme. For example, each time the phoneme “sh” is detected in the audio data, the corresponding video frame(s) can be identified as belonging to a “sh” viseme. The process of tagging video frames is handled by mapping system 20, which maps identified phonemes to visemes. Note that explicit identification of a given pose or expression is not required. Rather video frames belonging to known visemes are identified and categorized implicitly using phonemes. It should be understood that any number or types of visemes may be generated, including a silence viseme, which may comprise images that have no corresponding utterance for a fixed period of time (e.g., 1 second).

When a frame is identified as belonging to a viseme, the frame is stored in the viseme library 16. The viseme library 16 may be physically or logically arranged by viseme such that frames tagged as belonging to a common viseme are stored together in one of a plurality of model sets (e.g., V1, V2, V3, V4). Initially, each model set will comprise a null set of frames. As more frames are processed, each model set will grow. A threshold may be set for the size of given model set in order to avoid an overly large model set. A first-in first-out system of discarding frames may be utilized to eliminate excess frames after the threshold is met.

If an inputted frame does not correspond to a viseme, then frame decimation system 22 decimates or deletes the frame, i.e., sends it to trash 34. In this case, the frame is neither stored in viseme library 16, nor is it encoded by encoder 14. Note however that information regarding the position of any decimated frames may be explicitly or implicitly incorporated into the encoded video data 50. This information may be used by the receiver to determine where to reconstruct the decimated frames, as will be described below.

Assuming the inputted frame corresponds to a viseme, encoder 14 encodes the frame, e.g., using a block-by-block prediction strategy, which is then output as encoded video data 50. Encoder 14 comprises an error prediction system 24, detailed motion information 25, and a frame prediction system 26. Error prediction system 24 codes a prediction error in any known manner, e.g., such as that provided under the MPEG-2 standard. Detailed motion information 25 may be generated as side information that can be used by morphing system 48 at the receiver 40 (FIG. 2). Frame prediction system predicts the frame from two images; namely, (1) the motion-compensated previous coded frame generated by encoder 14, and (2) an image retrieved from the viseme library 16 by retrieval system 28. Specifically, the image retrieved from viseme library 16 is retrieved from the model set containing the same viseme as the frame being encoded. For example, if the frame contained an image in which a human face uttered the sound “sh,” a previous image from the same viseme would be selected and retrieved. The retrieval system 28 would retrieve the image that was closest in the mean-square sense. Thus, rather than relying on temporal proximity (i.e., neighboring frames), the present invention can select the closest match of any previous frame, regardless of the temporal proximity. By locating very similar previous frames, prediction errors are small, and very high degrees of compression can be readily achieved.

Referring now to FIG. 2, video receiver system 40 is shown containing decoder 42, reference frame library 44, buffer 46, and morphing system 48. Decoder 42 decodes incoming frames of encoded video data 50 using the parallel strategy as that of video packaging system 10. Specifically, an encoded frame is decoded using (1) the immediately previous decoded frame, and (2) an image from the reference frame library 44. The image from the reference frame library is the same one that was used to encode the frame, and can be readily identified with reference data stored in the encoded frame. After the frame is decoded, the frame is both stored in the reference frame library 44 (for decoding future frames) and forwarded to buffer 46.

In the case where one or more frames were originally decimated (e.g., shown as ? ?'s in buffer 46), morphing system 48 can be utilized to reconstruct the decimated frames by, for instance, interpolating between coded frames 53 and 55. Such interpolating techniques are taught for example in Ezzat and Poggio, “Miketalk: A talking facial display based on morphing visemes,” Proc. Computer Animation Conference, pages 96-102, Philadelphia, Pa, 1998, which is hereby incorporated by reference. Morphing system 48 may also use the detailed motion information provided by encoder 14 (FIG. 1). After the frames have been reconstructed, they can be outputted along with the decoded frames as a complete set of decoded video data 52.

It is understood that the systems, functions, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A video processing system for processing a stream of frames of video data, comprising a packaging system that includes:
a viseme identification system that determines if frames of inputted video data correspond to at least one predetermined viseme;
a viseme library for storing frames that correspond to the at least one predetermined viseme; and
an encoder for encoding each frame that corresponds to the at least one predetermined viseme, wherein the encoder utilizes a previously stored frame in the viseme library to encode a current frame.

2. The video processing system of claim 1, wherein the viseme identification system includes a speech segmenter that identifies phonemes in an audio data stream associated with the frames of video data.

3. The video processing system of claim 2, wherein the viseme identification system maps identified phonemes to the at least one predetermined viseme.

4. The video processing system of claim 2, wherein the viseme identification system tags frames with an associated phoneme.

5. The video processing system of claim 1, further comprising a frame decimation system that eliminates frames that do not correspond with the at least one viseme.

6. The video processing system of claim 1, wherein the encoder further utilizes an immediately previous encoded frame to encode the current frame.

7. The video processing system of claim 5, further comprising a receiver system that includes:
a decoder for decoding encoded frames of video data;
a frame reference library for storing decoded frames; and
wherein the decoder utilizes a previously decoded frame from the frame reference library to decode a current encoded frame, and wherein the previously decoded frame belongs to the same viseme as the current encoded frame.

8. The video processing system of claim 7, wherein the receiver system further comprises a morphing system that reconstructs frames eliminated by the decimation system.

9. The video processing system of claim 8, wherein the encoder generates detailed motion information that is used by the morphing system to reconstruct frames.

10. A method for processing a stream of frames of video data, comprising the steps of:
determining if each frame of inputted video data corresponds to at least one predetermined viseme;
storing frames that correspond to the at least one predetermined viseme in a viseme library; and
encoding each frame that corresponds to the at least one predetermined viseme, wherein the encoding step utilizes a previously stored frame in the viseme library to encode a current frame.

11. The method of claim 10, wherein the determining step identifies phonemes in an audio data stream associated with the frames of video data.

12. The method of claim 11, wherein the determining step maps identified phonemes to the at least one predetermined viseme.

13. The method of claim 11, wherein the determining step tags frames with an associated phoneme.

14. The method of claim 10, comprising the further step of eliminating frames that do not correspond with the at least one viseme.

15. The method of claim 10, wherein the encoding step further utilizes a previously encoded frame to encode the current frame.

16. The method of claim 14, comprising the further steps of:
decoding encoded frames of video data;
providing a frame reference library for storing decoded frames; and
wherein the decoding step utilizes a previously decoded frame from the frame reference library to decode a current encoded frame, and wherein the previously decoded frame belongs to the same viseme as the current encoded frame.

17. The method of claim 16, comprising the further step of reconstructing frames eliminated by the decimation system using a morphing system.

18. A program product stored on a recordable medium, which when executed, processes a stream of frames of video data, the program product comprising:
a system that determines if frames of inputted video data correspond to at least one predetermined viseme;
a viseme library for storing frames that correspond to the at least one predetermined viseme; and
a system for encoding each frame that corresponds to the at least one predetermined viseme, wherein the encoding system utilizes a previously stored frame in the viseme library to encode a current frame.

19. The program product of claim 18, wherein the determining system includes a speech segmenter that identifies phonemes in an audio data stream associated with the frames of video data.

20. The program product of claim 18, wherein the determining system maps identified phonemes to the at least one predetermined viseme.

21. A decoder for decoding encoded frames of video data that were encoded using frames associated with at least one predetermined viseme, comprising:
a frame reference library for storing decoded frames, wherein the decoder utilizes a previously stored frame in the frame reference library to decode a current encoded frame, and wherein the previously stored frame belongs to the same viseme as the current encoded frame; and
a morphing system that reconstructs frames of video data that were eliminated during an encoding process.

22. The decoder of claim 21, wherein the current encoded frame is further decoded using an immediately preceding decoded frame.
